(19) United States
(12) Patent Application Publication
(10) Pub. No.: US 2015/0283981 A1
(43) Pub. Date: Oct. 8, 2015

(54) METHOD AND APPARATUS FOR ADDING GREASE TO A WHEEL BEARING HUB ASSEMBLY

(71) Applicant: Marcus Stephen Bonner, Dryfork, WV (US)

(72) Inventor: Marcus Stephen Bonner, Dryfork, WV (US)

(21) Appl. No.: 14/677,630

(22) Filed: Apr. 2, 2015

Related U.S. Application Data
(60) Provisional application No. 61/974,164, filed on Apr. 2, 2014.

(51) Int. Cl. B60S 5/00; B60B 27/00; F16C 33/66

(52) U.S. Cl. CPC B60S 5/00; F16C 33/6622; B60B 27/0068; B60B 27/0005; B60B 2320/10

(57) ABSTRACT

A method of adding grease to a wheel bearing hub assembly is provided. The present invention includes a wheel bearing greaser. The wheel bearing greater is a fluid conduit that allows a user to pump grease into a wheel bearing hub assembly. The fluid conduit includes a first end and a second end. The first end is formed to attach to a tube and the second end is insertable into an ABS sensor cavity of the wheal bearing hub assembly. Once the fluid conduit is inserted into an ABS sensor cavity, grease may be pumped into the wheel bearing hub assembly.

### CROSS-REFERENCE TO RELATED APPLICATION

This application claims the benefit of priority of U.S. provisional application No. 61/974,164, filed Apr. 2, 2014, the contents of which are herein incorporated by reference.

### BACKGROUND OF THE INVENTION

The present invention relates to wheel bearing hub assemblies and, more particularly, to a method and apparatus for adding grease to a wheel bearing hub assembly.

A wheel hub assembly, also referred to as hub assembly, wheel hub unit, wheel hub bearing, etc., is an automotive part used in most cars, passenger vehicles and light and heavy trucks It is located between the brake drums or discs and the drive axle. On the axle side, it is mounted to the holding bracket from the chassis; on the disc side, the wheel is mounted to the bolts of the wheel hub assembly. When wheel hub bearing assemblies are low on grease, the assembly is prone to failure.

As can be seen, there is a need for a method and apparatus of adding grease or lubricant to the wheel hub assembly.

### SUMMARY OF THE INVENTION

In one aspect of the present invention, a method of adding grease to a wheel hub bearing assembly comprises: removing an anti lock braking system sensor from an anti lock braking system cavity of a wheel hub bearing assembly of a vehicle; inserting a fluid conduit at least partially into the anti lock braking system cavity of the wheel hub bearing assembly; and pumping grease through the fluid conduit and into an inner bearing housing of the wheel hub bearing assembly.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a section detail view of the present invention along line 2-2 in FIG. 1;

FIG. 3 is a perspective view of an embodiment of the present invention;

FIG. 4 is an exploded view of an embodiment of the present invention;

FIG. 5 is a perspective view of a wheel hub bearing assembly with the anti lock brake system (ABS) sensor prior to removal;

FIG. 6 is a perspective view demonstrating removal of ABS sensor from wheel hub bearing assembly;

FIG. 7 is an exploded view demonstrating application of the present invention to a wheel hub bearing assembly; and

FIG. 8 is a flow chart of a method of adding grease to a wheel hub bearing assembly.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a method and apparatus used to grease sealed wheel hub bearing assemblies. The present invention introduces grease or lubricant to a sealed wheel bearing and hub assembly that are low or empty on grease or lubricant. The wheel bearing greater of the present invention allows the grease to go into the sealed wheel bearing and hub assembly while also letting the displaced air escape through the same passage.

The present invention involves removing the anti lock braking system (ABS) sensor from the sealed wheel bearing and hub assembly. The user then gains access to the grease or lubricant holding cavity inside of the sealed wheel bearing and hub assembly. The wheel bearing greater is a conduit that allows a grease gun to pump grease into the wheal bearing hub assembly. Therefore, a user is able to replenish grease or lubricant into the wheel bearings preventing premature wheel bearing failure.

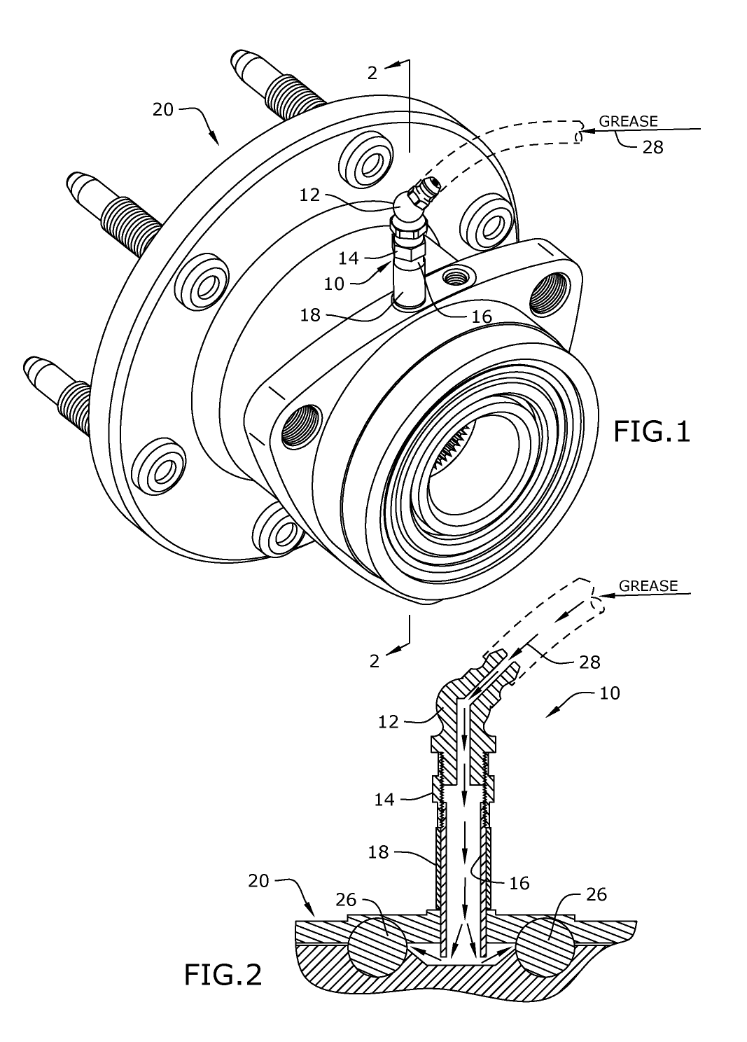

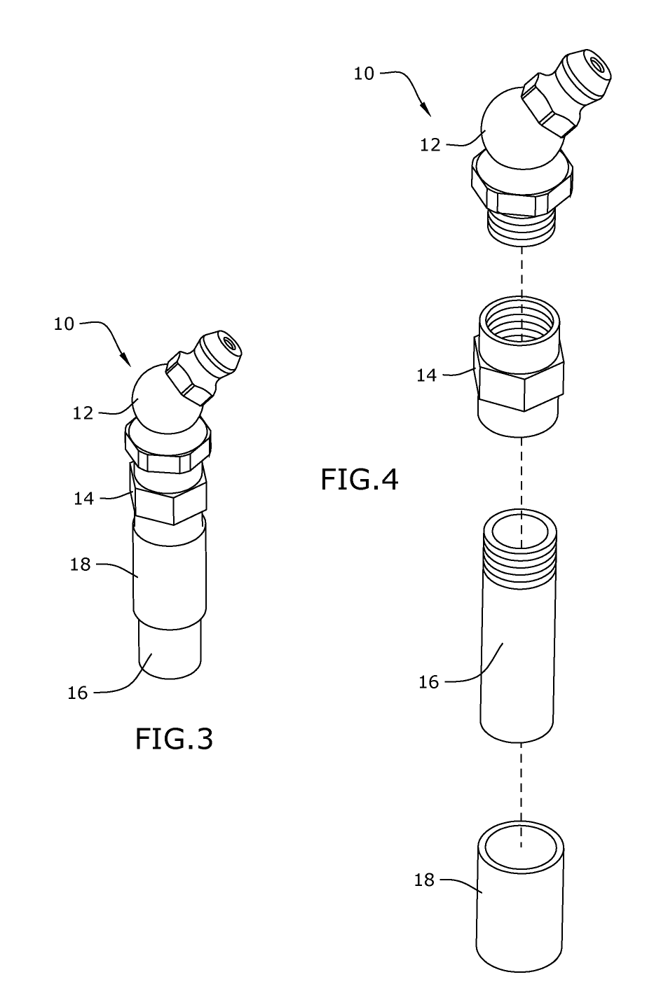

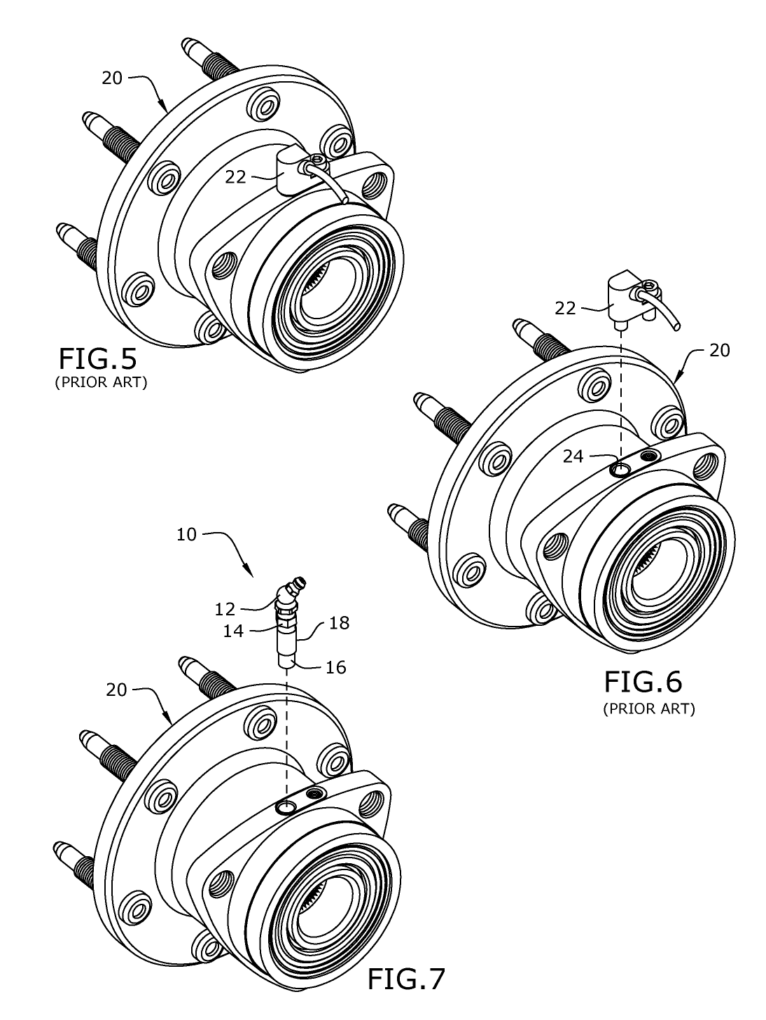

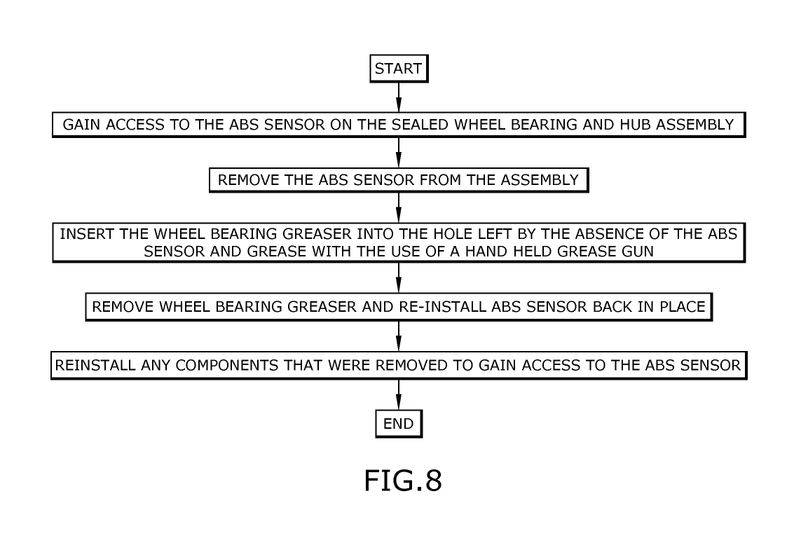

Referring to FIGS. 1 through 8, the present invention includes a wheel bearing greaser. The wheel bearing greater is a fluid conduit 10 that allows a user to pump grease 28 into a wheel bearing hub assembly 20. The fluid conduit 10 includes a first end and a second end. The first end is formed to attach to a tube and the second end is insertable into an ABS sensor cavity 24 of the wheel bearing hub assembly 20. In certain embodiments, the first end is a tub fitting 12 and the second end is a nipple 16.

As illustrated in FIG. 4, the tube fitting 12 includes a male threaded bottom end, and the nipple 18 includes a male threaded top end. A threaded coupler 14 may include a female threaded inner portion. The male threaded bottom end of the tube fitting 12 may attach to the top end of the threaded coupler 14 via the female threaded inner portion. The male threaded top end of the nipple 16 may attach to the bottom end of the threaded coupler 14 via the female threaded inner portion. Therefore, the threaded coupler 14 may secure the tube fitting 12 and the nipple 16 together. A heat shrink 18 may secure around the nipple 16.

In certain embodiments, the wheel bearing greater is made up of a ⅛ inch brass pipe coupler 14, a ⅛ inch brass pipe nipple 16 that is 1.5 inches long with threads on one end and no threads on the other end, a ⅛ inch pipe thread grease tube fitting 12 with about a 45 degree angled head nozzle, and a piece of heat shrink about ⅝ inch long. However, the dimensions described above may be altered and the wheel bearing greater may still perform the method described below.

A method of adding grease to a wheel bearing may include the following. A user gains access to the ABS sensor 22 on the wheel bearing hub assembly 20. The ABS sensor 22 is removed from an ABS cavity 24 of a wheel bearing hub assembly 20 of a vehicle. The fluid conduit 10 is inserted at least partially into the ABS cavity 24 of the wheel bearing hub assembly 20. Grease 28 may be pumped through the fluid conduit 10 and into an inner bearing housing 26 of the wheel bearing hub assembly 20. Once the inner bearing housing 26 is replenished with grease 28, the fluid conduit 10 is removed from the anti lock braking system cavity 24. The anti lock braking system sensor 22 is inserted into the anti lock braking system cavity 24 to reassemble the wheal bearing hub assembly 20.

It should be understood, of course, that the foregoing relates to exemplary embodiments of the invention and that modifications may be made without departing from the spirit and scope of the invention as set forth in the following claims.

What is claimed is:

1. A method of adding grease to a wheel hub bearing assembly comprising:
removing an anti lock braking system sensor from an anti lock braking system cavity of a wheel hub bearing assembly of a vehicle;
inserting a fluid conduit at least partially into the anti lock braking system cavity of the wheel hub bearing assembly; and
pumping grease through the fluid conduit and into an inner bearing housing of the wheel hub bearing assembly.

2. The method of claim 1, wherein the fluid conduit comprises a tube fitting operable to secure a tube, and a nipple insertable into the anti lock braking system cavity.

3. The method of claim 2, wherein the tube fitting comprises a threaded bottom end, and the nipple comprises a threaded top end, wherein a threaded coupler connects the tube fitting and the nipple.

4. The method of claim 2, wherein a heat shrink surrounds the nipple.

5. The method of claim 1, further comprising the steps of
removing the fluid conduit from the anti lock braking system cavity once the inner bearing housing is replenished with grease; and
inserting the anti lock braking system sensor into the anti lock braking system cavity.
